(19) United States
(12) Patent Application Publication
(10) Pub. No.: US 2024/0099309 A1
(43) Pub. Date: Mar. 28, 2024

(54) Use of Microorganisms to Improve Plant Immune Response

(71) Applicant: Locus Solutions IPCo, LLC, Solon, OH (US)

(72) Inventors: Sean FARMER, Ft. Lauderdale, FL (US); Ken ALIBEK, Solon, OH (US); Paul ZORNER, Encinitas, CA (US)

(21) Appl. No.: 18/012,069

(22) PCT Filed: Sep. 7, 2022
(86) PCT No.: PCT/US2022/042754

§ 371 Date: Dec. 21, 2022

Related U.S. Application Data
(60) Provisional application No. 63/241,743, filed on Sep. 8, 2021.

(51) Int. Cl. A01N 63/38; A01N 63/22; A01P 1/00; C05D 1/02

(52) U.S. Cl. CPC A01N 63/38; A01N 63/22; A01P 1/00; C05D 1/02

(57) ABSTRACT

Compositions and methods are provided for improving a plant's immune response using a combination of microbes and/or their growth by-products. Specifically, the subject invention improves a plant's ability to withstand an infection by a pest or pathogen using a combination of a Trichoderma sp. fungus and a Bacillus sp. bacterium, and, optionally, one or more other microorganisms. In certain embodiments, the compositions and methods of the subject invention can modulate the recognition of PAMPs and/or the induction of defensive mechanisms in a plant. In a specific embodiment, the invention reduces induction of self-harming defensive mechanisms that are irreversible and/or over-induced in the plant.

### CROSS-REFERENCE TO RELATED APPLICATION

This application claims priority to U.S. Provisional Patent Application No. 63/241,743, filed Sep. 8, 2021, which is incorporated herein by reference in its entirety.

### BACKGROUND OF THE INVENTION

In the agriculture industry, certain common issues continue to hinder the ability of growers to maximize production yields while keeping costs low. These include, but are not limited to, infections and infestations caused by bacteria, fungi, nematodes and other pests and pathogens; the high costs of chemical fertilizers and herbicides, including their environmental and health impacts; and the difficulty for plants to efficiently absorb nutrients and water from different types of soil.

In citrus production, for example, widespread infection of citrus plants by pathogens such as those that cause citrus greening disease and citrus canker disease has led to significant hardships for citrus growers. As much as entire crops have been lost to these bacterial infections, leading to a decline in the production, and increase in price, of citrus products worldwide.

Citrus greening disease, which is also known is Huanglongbing (HLB) or yellow dragon disease, is an incurable infection caused by Candidatus Liberibacter spp. bacteria, namely Candidatus Liberibacter asiaticus, Candidatus Liberibacter africanus and Candidatus Liberibacter americanus. All Ca. Liberibacter spp. belong to the family Rhizobiacea and are transmitted by at least two species of citrus psyllids, Diaphorina citri Kuwayama (Asian citrus psyllid) and Trioza erytreae (del Guercio) (African citrus psyllid). (de Graca et al. 2016).

HLB has devastated millions of acres of citrus crops throughout the United States and other parts of the world. Infected trees produce fruits that are green, misshapen and bitter, which are unsuitable for sale. On a cellular level, the HLB pathogen is thought to reside mainly intracellularly, causing distinct yet interrelated symptoms, such as starch accumulation in the sieve elements, plugged sieve pores, hypertrophic phloem parenchyma cells, structural changes of phloem tissue, phloem plugging with abundant callose depositions, phloem cell wall distortion and thickening, and eventually phloem collapse and necrosis. These changes can cause a cascade of further symptoms affecting, for example, photosynthesis, respiration and energy availability. In general, most of the serious symptoms of HLB infection are a result of phloem disruption.

When plants are infected by a pest or pathogen, such as HLB, their cells implement various defensive mechanisms against the invading specimen. Plants do not have immune cells, per se, but have evolved what can be characterized as an innate immune system, where most or all of their cells exhibit immune capabilities.

Two types of immune pathways can be triggered in plants in response to infection or attack. The first pathway involves pattern recognition receptors (PRR), which are proteins on plant cell surfaces that recognize different molecules associated with invaders. These invader molecules are known as pathogen-associated molecular patterns (PAMPs), and can be attached to the surface of a pathogen and/or released by the pathogen upon infection. (Keener 2016).

Pathogen structures are detected by the PRR extracellular domain, with subsequent signal transduction in the cytoplasm. PAMP recognition leads to one or more defensive signals, including, for example, an oxidative burst by the generation of reactive oxygen species (ROS), calcium influx, activation of the mitogen-activated protein kinase (MAPK) cascade, nitric oxide (NO) burst, ethylene production, callose deposition at the cell wall, and expression of defense-related genes involved in immunity responses. (Dalio et al. 2017).

Some pathogens have evolved methods of overcoming the PAMP-triggered immunity using “effector” molecules, which interfere with the plant's initial defensive mechanisms. In response, however, many plants also evolved a second immunity pathway-effector-triggered immunity (ETI). Similarly to PRR of PAMPs, plants can recognize effector molecules and initiate secondary immune cascades that boost the PAMP-triggered responses. In some instances, the plant undergoes hypersensitive response, where localized plant cell death occurs to limit the spread of infection. (Keener 2016).

There are also instances where a plant's immune response can be improved prior to a serious pathogenic infection. Somewhat analogously to how a vaccine works, the plant's immune system can be “primed” or “pre-conditioned” by pre-exposure to priming agents, or molecules that are associated with a stressor or invader. Priming can occur as a result of, for example, interactions between a plant and a pathogen, a beneficial microorganism (e.g., rhizobacteria, mycorrhizal fungi), or by a natural or synthetic agricultural chemical. The plant is then placed into an induced state of defense and/or enhanced resistance, thus priming it for resisting and/or defending against a future attack. Following such responses, plants are cellularly and organismally reprogrammed to “remember” the exposure at a molecular level, thus responding with more intensity, speed and/or sensitivity compared with non-primed plants in response to the same stress conditions. (Tugizimana et al. 2018).

The immune response mechanisms of citrus plants in response to infection by Ca. Liberibacter spp. is not well-known at this point. Infected citrus trees exhibit a progressive degeneration of phloem tissue that can lead to collapse of the phloem. A series of interrelated symptoms further cause harm to the tree, and can eventually lead to its death. One of the first observable signs that an infection has occurred is swelling of the middle lamella between and surrounding sieve elements. This swelling is followed by the deposition of callose plugs in lateral pit fields and in/around sieve plates.

Cell walls begin to collapse concurrently with increased deposition of callose and P-protein plugs at the sieve plates. Callose plugs and phloem collapse is thought to obstruct the transport of photoassimilates (nitrogenous and reduced carbon compounds produced during photosynthesis). As the flow of photoassimilates is progressively obstructed, starch granules begin to accumulate in sieve elements and all parenchyma cell types along the radial and longitudinal transport pathway. (Broderson et al. 2014). The impairment of photoassimilate transport is one of the mains causes of shoot yellowing, blotchy leaves, and overall tree decline. (Zou et al. 2012).

The economic costs due to pathogenic microorganisms that infect agricultural crops are widespread, and current methods of combatting crop failures are inadequate. HLB, in particular, possesses enhanced virulence, which is apparent in the widespread citrus crop losses and the inability of citrus growers to fight the disease once their citrus groves have been infected.

Thus, there is a continuing need for products to improve the immune response of plants that have been, or at risk for being, infected by potentially devastating crop pathogens, such as HLB.

### BRIEF SUMMARY OF THE INVENTION

The subject invention provides microbe-based products, as well as methods of using these microbe-based products in agricultural applications. More specifically, the subject invention provides microbe-based immune supplement compositions and methods of their use for improving the immune response of plants that are, or are at risk of being, infected by a pest or a pathogen.

In certain embodiments, the pest or pathogen is a Ca. Liberibacter spp. bacterium, such as Candidatus Liberibacter asiaticus (“citrus greening disease,” “Huanlongbing” or “HLB”). Advantageously, the microbe-based products and methods of the subject invention are environmentally-friendly, non-toxic and cost-effective.

In preferred embodiments, the subject invention provides a microbe-based immune supplement composition for improving a plant's immune response, the composition comprising a combination of microorganisms and/or their growth by-products. Also provided are methods of cultivating the microorganisms and/or growth by-products of the immune supplement composition.

In one embodiment, the immune supplement composition comprises a first microorganism and a second microorganism. More specifically, the first microorganism is a conidia-forming (i.e., spore-forming), non-pathogenic fungal strain, and the second microorganism is a spore-forming, non-pathogenic bacterial strain. Preferably, the composition comprises a Trichoderma sp. fungus and a Bacillus sp. bacterium, although other combinations are envisioned. Even more preferably, the composition comprises Trichoderma harzianum and a strain of Bacillus amyloliquefaciens, e.g., B. amyloliquefaciens NRRL B-67928.

In one embodiment, the composition can comprise from 1 to 99% Trichoderma by volume and from 99 to 1% Bacillus by volume. In preferred embodiments, the ratio of Trichoderma to Bacillus is about 1:100 to 100:1, about 1:50 to 50:1, about 1:10 to 10:1, or about 1:4 to 4:1.

In one embodiment, the composition can comprise one or more additional and/or alternative beneficial microorganisms, such as, for example, Wickerhamomyces anomalus, Meyerozyma guilliermondii, Meyerozyma caribbica, Myxococcus xanthus, a nitrogen-fixing bacteria, e.g., Azotobacter vinelandii, and/or a potassium-mobilizing bacteria, e.g., Frateuria aurantia.

The microorganisms of the subject compositions can be obtained through cultivation processes ranging from small to large scale. These cultivation processes include, but are not limited to, submerged cultivation/fermentation, solid state fermentation (SSF), and modifications, hybrids and/or combinations thereof. In preferred embodiments, the microbes are cultivated using SSF or modifications thereof.

The composition can comprise the leftover fermentation substrate and/or purified or unpurified growth by-products, such as biosurfactants, enzymes and/or other metabolites. The microbes can be live or inactive.

The composition is preferably formulated for application to soil, seeds, whole plants, or plant parts (including, but not limited to, roots, tubers, stems, flowers and leaves). In certain embodiments, the composition is formulated as, for example, liquid, dust, granules, microgranules, pellets, wettable powder, flowable powder, emulsions, microcapsules, oils, or aerosols. In preferred embodiments, the immune supplement composition is a soil treatment composition.

To improve or stabilize the effects of the composition, it can be blended with suitable adjuvants and then used as such or after dilution, if necessary. In certain embodiments, the composition is formulated as a concentrated liquid preparation, or as dry powder or dry granules that can be mixed with water and other components to form a liquid product. In one embodiment, the composition comprises the substrate, microbes and growth by-products, blended together and dried to form powder or granules.

In one embodiment, the composition can comprise glucose (e.g., in the form of molasses), glycerol, glycerin, and/or other osmoticum substances, to promote osmotic pressure during storage and transport of the dry product.

The composition can be used either alone or in combination with other compounds for efficiently improving a plant's immune response, enhancing the overall health of the plant, enhancing the rate of plant growth, and/or enhancing the marketable yield of the plant. For example, in some embodiments, the composition can comprise additional components, such as herbicides, fertilizers, pesticides and/or soil amendments. In one embodiment, the composition can be mixed and/or applied with a commercial fertilizer, such as Scott's Miracle-Gro®, or another source of nutrients (e.g., nitrogen-phosphorous-potassium (NPK)). Additional elements include, for example, nutrients and/or micronutrients, such as magnesium, phosphate, nitrogen, potassium, selenium, calcium, sulfur, iron, copper, and zinc, and/or prebiotics, such as kelp extract, fulvic acid, humate and/or humic acid. The exact materials and the quantities thereof can be determined by a grower or an agricultural scientist having the benefit of the subject disclosure.

In preferred embodiment, methods are provided for improving a plant's immune response, wherein a combination of beneficial microorganisms, and/or their growth by-products, are contacted with the plant and/or its surrounding environment. More specifically, the methods can comprise contacting an immune supplement composition comprising a first microorganism and a second microorganism, and/or a growth by-product of one or both of these microorganisms, with the plant and/or its surrounding environment. Preferably, the first microorganism is a Trichoderma sp. fungus and the second microorganism is a Bacillus sp. bacterium. In some embodiments, the methods can further comprise applying one or more additional microorganisms.

In certain embodiments, the plants are citrus plants, including, for example, all varieties of orange, lemon, lime, pomelo and grapefruit trees. Other types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), and managed pastures (any mix of plants used to support grazing animals).

In certain preferred embodiments, the plants are, or are at risk of being, infected by a Ca. Liberibacter spp. bacterium, such as Ca. Liberibacter asiaticus, Ca. Liberibacter africanus and/or Ca. Liberibacter americanus. In a specific embodiment, the bacterium is Ca. Liberibacter asiaticus (HLB).

Plants that are “at risk” of being infected include citrus plants in general; citrus plants growing in a grove where infected trees and/or Ca. Liberibacter vectors, including Asian citrus psyllid and African citrus psyllid, have been detected; and citrus plants growing in regions that have experienced loss of citrus trees and/or yields due to HLB infections.

In certain embodiments, the microorganisms of the composition work synergistically with one another to improve the plant's immune response.

In one embodiment, improvement in the plant's immune response comprises enhancing the ability of the plant's pattern recognition receptors (PRR) to recognize an invader-associated molecular pattern (IAMP) and/or a pathogenic effector molecule and subsequently react to said recognition by transmitting a signal inside the plant cells that induces a defense mechanism. In certain embodiments, the IAMP is a pathogen-associated molecular pattern (PAMP).

In some embodiments, the immune supplement serves as a priming agent, wherein priming comprises pre-exposing the plant to an IAMP and/or a pathogenic effector molecule, thus triggering a defense mechanism in the plant and inducing the plant into a state of defense and/or resistance prior to the plant being infected by a pathogen.

In some embodiments, improvement in the plant's immune response comprises enhancing the reaction of the plant's PRR upon recognition of an IAMP and/or pathogenic effector molecule. For example, the methods can enhance induction of a defense mechanism in the plant by, for example, increasing the speed at which a signal is produced and/or transmitted by the PRR, and/or increasing the quantity at which a defense mechanism (e.g., a defensive molecule) is deployed by the plant.

In certain embodiments, improvement in the plant's immune response comprises reducing the reaction of the plant's PRR upon recognition of an IAMP and/or pathogenic effector molecule. For example, the methods can reduce induction of a defense mechanism that is causing harm to the plant because, for example, it is irreversible and/or it is being over-induced in the plant.

Plant defense mechanisms modulated according to the subject methods, include, but are not limited to, release of an anti-microbial compound in the plant to control pathogenic invaders; production of a reactive oxygen species (ROS); hypersensitive response (HR), or programmed cell death, at the site of infection; alterations in gene expression and/or hormone expression to up- or down-regulate certain defensive and/or protective mechanisms; up-regulation of carbohydrate synthesis; alteration of gene expression encoding proteins involved in cell wall synthesis, assembly and modification, including phloem proteins; up-regulation of callose deposition in parts of the plant; and/or others.

In certain embodiments, the immune supplement composition is contacted with a plant part. In a specific embodiment, the composition is contacted with one or more roots of the plant. The composition can be applied directly to the roots, e.g., by spraying or dunking the roots, and/or indirectly, e.g., by administering the composition to the soil in which the plant grows (e.g., the soil surface and/or the rhizosphere). The composition can be applied to the seeds of the plant prior to or at the time of planting, or to any other part of the plant and/or its surrounding environment.

The methods can further comprise applying materials to enhance the growth of the beneficial microbes during application (e.g., added nutrients and/or prebiotics).

Additionally, in one embodiment, the method can be used to inoculate a rhizosphere with a beneficial microorganism. The microorganisms of the immune supplement composition can colonize the rhizosphere and provide multiple benefits to the plant whose roots are growing therein, including, for example, protection and nourishment.

Advantageously, the present invention can be used without releasing large quantities of inorganic compounds into the environment. Additionally, the compositions and methods utilize components that are biodegradable and toxicologically safe. Thus, the present invention can be used as a “green” soil treatment.

### DETAILED DESCRIPTION OF THE INVENTION

The subject invention provides microbe-based products, as well as methods of using these microbe-based products in agricultural applications. More specifically, the subject invention provides microbe-based immune supplement compositions and methods of their use for improving the immune response of plants that are, or are at risk of being, infected by a pest or a pathogen.

In certain embodiments, the pest or pathogen is a Ca. Liberibacter spp. bacterium, such as Candidatus Liberibacter asiaticus (“citrus greening disease,” “Huanlongbing” or “HLB”). Advantageously, the microbe-based products and methods of the subject invention are environmentally-friendly, non-toxic and cost-effective.

In preferred embodiments, the subject invention provides a microbe-based immune supplement composition for improving a plant's immune response, the composition comprising a combination of microorganisms and/or their growth by-products. Also provided are methods of cultivating the microorganisms and/or growth by-products of the immune supplement composition.

### Selected Definitions

The subject invention utilizes “microbe-based compositions,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In preferred embodiments, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply the microbe-based composition harvested from the microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” in the context of fermentation of a microbe-based composition refers to removing some or all of the microbe-based composition from a growth vessel.

As used herein, a “biofilm” is a complex aggregate of microorganisms, wherein the cells adhere to each other and/or to surfaces. In some embodiments, the cells secrete a polysaccharide barrier that surrounds the entire aggregate. The cells in biofilms are physiologically distinct from planktonic cells of the same organism, which are single cells that can float or swim in liquid medium.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, biosurfactants, biopolymers, enzymes, acids, solvents, alcohols, proteins, vitamins, minerals, microelements, and amino acids.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduce” refers to a negative alteration, and the term “increase” refers to a positive alteration, each of at least 1%, 5%, 10%, 25%, 50%, 75%, or 100%.

As used herein, “reference” refers to a standard or control condition.

As used herein, “surfactant” refers to a compound that lowers the surface tension (or interfacial tension) between two liquids or between a liquid and a solid. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture is the care, monitoring and maintenance of soil.

As used herein, the term “control” used in reference to a pest or pathogen extends to the act of killing, disabling, immobilizing, or reducing population numbers of the pest or pathogen, or otherwise rendering the pest or pathogen substantially incapable of reproducing and/or causing harm.

As used herein, a “pathogen” or “pathogenic” organism is any organism that is capable of causing a disease in another organism. Typically, pathogenic organisms are infectious agents and can include, for example, bacteria, viruses, fungi, molds, protozoa, prions, parasites, helminths, and algae.

As used herein, a “pest” is any organism, other than a human, that is destructive, deleterious and/or detrimental to humans or human concerns (e.g., agriculture, horticulture). In some, but not all instances, a pest may be a pathogenic organism. Pests may cause or be a vector for infections, infestations and/or disease, or they may simply feed on or cause other physical harm to living tissue. Pests may be single- or multi-cellular organisms, including but not limited to, viruses, fungi, bacteria, parasites, and/or nematodes.

As used herein “preventing” or “prevention” of a disease, condition or disorder means delaying, inhibiting, suppressing, forestalling, and/or minimizing the onset or progression of a particular sign or symptom thereof. Prevention can include, but does not require, indefinite, absolute or complete prevention, meaning the sign or symptom may still develop at a later time. Prevention can include reducing the severity of the onset of such a disease, condition or disorder, and/or inhibiting the progression of the condition or disorder to a more severe condition or disorder.

As used herein, a “soil treatment,” “soil amendment” or a “soil conditioner” is any compound, material, or combination of compounds or materials that are added into soil to enhance the physical properties of the soil. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the growth and health of plants by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Plant Immune Supplement Compositions

In one embodiment, the subject invention provides microbe-based immune supplement compositions for plants, the compositions comprising a combination of microorganisms and/or their growth by-products. The immune supplement composition can be used to improve a plant's innate immune system so that, if the plant is infected by a pathogen or disease, presently or in the future, the plant will exhibit, for example, improved resistance and/or defensive responses to the infection.

Advantageously, the subject composition can be used to enhance the overall health and/or vigor of the plant, enhance the plant's rate of growth, and/or enhance the marketable yields of the plant, despite being infected by a pathogen and/or being at risk of being infected. In certain embodiments, the immune supplement composition can also be used to inoculate plant roots with a beneficial microorganism.

Advantageously, the microbe-based compositions according to the subject invention are non-toxic and can be applied in high concentrations without causing irritation to, for example, the skin or digestive tract of a human or other non-pest animal. Thus, the subject invention is particularly useful where application of the microbe-based compositions occurs in the presence of living organisms, such as growers and livestock.

In one embodiment, the immune supplement composition can comprise a first microorganism, which is preferably a conidia-forming (spore-forming) fungal strain, and a second microorganism, which is preferably a spore-forming bacterial strain. Preferably, the first microorganism is a Trichoderma sp. fungus and the second microorganism is a spore-forming Bacillus sp. bacterium, although other combinations are envisioned. In certain embodiments, the composition comprises Trichoderma harzianum and Bacillus amyloliquefaciens. In a specific embodiment, the strain of B. amyloliquefaciens is B. amyloliquefaciens subsp. locus, also known as B. amyloliquefaciens NRRL B-67928.

In one embodiment, the composition can comprise from 1 to 99% Trichoderma by volume and from 99 to 1% Bacillus by volume. In some embodiments, the ratio of Trichoderma to Bacillus is about 1:100 to about 100:1, about 1:50, to about 50:1, about 1:25 to about 25:1, about 1:10 to about 10:1, about 1:9 to about 9:1, about 1:8 to about 8:1, about 1:7 to about 7:1, about 1:6 to about 6:1, about 1:5 to about 5:1 or about 1:4 to about 4:1.

In one embodiment, the microorganisms of the subject composition comprise about 5 to 20% of the total composition, or about 8 to 15%, or about 10 to 12% by weight. In one embodiment, the composition comprises about 1×10⁶ to 1×10¹², 1×10⁷ to 1×10¹¹, 1×10⁸ to 1×10¹⁰, or 1×10⁹ CFU/ml of Trichoderma. In one specific embodiment, the composition comprises about 1×10⁶ to 1×10¹², 1×10⁷ to 1×10¹¹, 1×10⁸ to 1×10¹⁰, or 1×10⁹ CFU/ml of Bacillus.

In some embodiments, the composition can comprise one or more additional and/or alternative microbes. In one embodiment, the other microbes can comprise one or more of, for example, a bacterium, a yeast and/or a fungus.

In one exemplary embodiment, the composition comprises, for example, Myxococcus xanthus, Pseudomonas chlororaphis, Starmerella bombicola, Saccharomyces boulardii, Pichia occidentalis, Pichia kudriavzevii, Wickerhamomyces anomalus (e.g., NRRL Y-68030), mycorrhizal fungi, Meyerozyma guilliermondii and/or Meyerozyma caribbica (e.g., M caribbica “MEC14XN”).

In certain embodiments, the additional microbes are capable of fixing, solubilizing and/or mobilizing nitrogen, potassium, phosphorous (or phosphate) and/or other micronutrients in soil. In one embodiment, a nitrogen-fixing bacterium can be included, such as, for example, Azotobacter vinelandii, B. amyloliquefaciens NRRL B-67928, Bacillus subtilis NRRL B-68031, Meyerozyma guilliermondii and/or Meyerozyma caribbica (e.g., M caribbica “MEC14XN”). In another embodiment, a potassium-mobilizing microbe can be included, such as, for example, Frateuria aurantia. In yet another embodiment, a phosphorus-mobilizing microorganism can be included, such as, for example, Pichia spp., and Wickerhamomyces anomalus (e.g., NRRL Y-68030).

In a specific embodiment, the one or more additional microbes are added at a concentration of 1×10⁶ to 1×10¹² or 1×10⁹ to 1×10¹⁰ CFU/ml each.

The species and ratio of microorganisms and other ingredients in the composition can be customized according to, for example, the plant being treated, the soil type where the plant is growing, the health of the plant at the time of treatment, as well as other factors.

The microbes and microbe-based compositions of the subject invention can have a number of beneficial properties that are useful for enhancing plant health, growth and/or yields. For example, the compositions can comprise products resulting from the growth of the microorganisms, such as biosurfactants, proteins and/or enzymes, either in purified or crude form.

In one embodiment, the microorganisms of the subject composition are capable of producing a biosurfactant. In another embodiment, biosurfactants can be produced separately by other microorganisms and added to the composition, either in purified form or in crude form.

Biosurfactants form an important class of secondary metabolites produced by a variety of microorganisms such as bacteria, fungi, and yeasts. As amphiphilic molecules, microbial biosurfactants reduce the surface and interfacial tensions between the molecules of liquids, solids, and gases. Furthermore, the biosurfactants according to the subject invention are biodegradable, have low toxicity, are effective in solubilizing and degrading insoluble compounds in soil and can be produced using low cost and renewable resources. They can inhibit adhesion of undesirable microorganisms to a variety of surfaces, prevent the formation of biofilms, and can have powerful emulsifying and demulsifying properties. Furthermore, the biosurfactants can also be used to improve wettability and to achieve even solubilization and/or distribution of fertilizers, nutrients, and water in the soil.

Biosurfactants according to the subject methods can be selected from, for example, low molecular weight glycolipids (e.g., sophorolipids, rhamnolipids, mannosylerythritol lipids and trehalose lipids), lipopeptides (e.g., surfactin, iturin, fengycin, arthrofactin and lichenysin), cellobiose lipids, flavolipids, phospholipids (e.g., cardiolipins), and high molecular weight polymers such as lipoproteins, lipopolysaccharide-protein complexes, and polysaccharide-protein-fatty acid complexes.

The composition can comprise one or more biosurfactants at a concentration of 0.001% to 10%, 0.01% to 5%, 0.05% to 2%, and/or from 0.1% to 1% by weight.

The immune supplement composition can comprise the fermentation medium containing a live and/or an inactive culture, the purified or crude form growth by-products, such as biosurfactants, enzymes, and/or other metabolites, and/or any residual nutrients.

The product of fermentation may be used directly, with or without extraction or purification. If desired, extraction and purification can be easily achieved using standard extraction and/or purification methods or techniques described in the literature.

Advantageously, in accordance with the subject invention, the immune supplement composition may comprise the medium in which the microbes were grown. The composition may be, for example, at least, by weight, 1%, 5%, 10%, 25%, 50%, 75%, or 100% growth medium. The amount of biomass in the composition, by weight, may be, for example, anywhere from 0% to 100%, 10% to 90%, 20% to 80%, 30% to 70%, 40% to 60%, and/or about 50%.

The microorganisms in the immune supplement composition may be in an active or inactive form, or in the form of vegetative cells, reproductive spores, mycelia, hyphae, conidia or any other form of microbial propagule. The composition may also contain a combination of any of these microbial forms.

In one embodiment, different species of microorganism are grown separately and then mixed together to produce the soil treatment composition. In one embodiment, microorganisms can be co-cultivated, for example, B. amyloliquefaciens and M. xanthus.

In one embodiment, the composition is preferably formulated for application to soil, seeds, whole plants, or plant parts (including, but not limited to, roots, tubers, stems, flowers and leaves). In certain embodiments, the composition is formulated as, for example, liquid, dust, granules, microgranules, pellets, wettable powder, flowable powder, emulsions, microcapsules, oils, or aerosols.

To improve or stabilize the effects of the composition, it can be blended with suitable adjuvants and then used as such or after dilution, if necessary. In preferred embodiments, the composition is formulated as a liquid, a concentrated liquid, or as dry powder or granules that can be mixed with water and other components to form a liquid product.

In one embodiment, the composition can comprise glucose (e.g., in the form of molasses), glycerol and/or glycerin, as or in addition to an osmoticum substance, to promote osmotic pressure during storage and transport of the dry product.

The compositions can be used either alone or in combination with other compounds and/or methods for efficiently enhancing plant health, growth and/or yields, and/or for supplementing the growth of the microbes. For example, in one embodiment, the composition can include and/or can be applied concurrently with nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. In some embodiments, the microorganisms of the composition produce and/or provide these substances. The exact materials and the quantities thereof can be determined by a grower or an agricultural scientist having the benefit of the subject disclosure.

The compositions can also be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments. Preferably, however, the composition does not comprise and/or is not used with benomyl, dodecyl dimethyl ammonium chloride, hydrogen dioxide/peroxyacetic acid, imazilil, propiconazole, tebuconazole, or triflumizole.

If the composition is mixed with compatible chemical additives, the chemicals are preferably diluted with water prior to addition of the subject composition.

Further components can be added to the composition, for example, buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, stabilizers and ultra-violet light resistant agents.

The pH of the microbe-based composition should be suitable for the microorganism of interest. In a preferred embodiment, the pH of the composition is about 3.5 to 7.0, about 4.0 to 6.5, or about 5.0.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The microbe-based compositions may be used without further stabilization, preservation, and storage, however. Advantageously, direct usage of these microbe-based compositions preserves a high viability of the microorganisms, reduces the possibility of contamination from foreign agents and undesirable microorganisms, and maintains the activity of the by-products of microbial growth.

In other embodiments, the composition can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 pint to 1,000 gallons or more. In certain embodiments the containers are 1 gallon, 2 gallons, 5 gallons, 25 gallons, or larger.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Microbial Strains

The microorganisms useful according to the subject invention can be, for example, non-plant-pathogenic strains of bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganism is a yeast or fungus. Yeast and fungus species suitable for use according to the current invention, include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Meyerozyma (e.g., M. guillidermondii, M. caribbica) Mortierella, Mycorrhiza, Penicillium, Phycomyces, Pichia (e.g., P. anomala, P. guilliermondii, P. occidentalis, P. kudriavzevii), Pseudozyma (e.g., P. aphidis), Saccharomyces (e.g., S. boulardii, S. cerevisiae, S. torula), Starmerella (e.g., S. bombicola), Torulopsis, Trichoderma (e.g., T reesei, T. harzianum, T hamatum, T. viride), Ustilago (e.g., U. maydis), Wickerhamomyces (e.g., W. anomalus), Williopsis (e.g., W. mrakii), Zygosaccharomyces (e.g., Z. bailii), and others.

In a preferred embodiment, the microorganism is a spore-producing Trichoderma sp. fungus. In a specific preferred embodiment, the microorganism is Trichoderma harzianum.

Certain species of Trichoderma are useful when added to soil, where they can multiply and grow in close association with plants' roots. They are capable of partially protecting the roots from invasion by other plant pathogenic fungi and other microbial and animal pests, in addition to helping to stimulate plant growth.

Trichoderma can establish strong and long-lasting colonization of root surfaces, penetrating into the epidermis and shallow subsurface cells. These root-microorganism associations cause substantial changes to the plant proteome and metabolism. They produce and/or release a variety of compounds that induce localized or systemic resistance responses, causing a lack of pathogenicity to plants.

Additionally, plants are protected from numerous classes of plant pathogen by responses that are similar to systemic acquired resistance and rhizobacteria-induced systemic resistance. Trichoderma spp. can effectively reduce diseases caused by some soil-borne plant pathogens. For example, the species T. harzianum, T. hamatum, and T. viride have fungicidal activity against Sclerotium, Rhizoctonia, Solani, Pythium, Fusarium, Cercospora, Ralstonia, Fragaria, Rhizopus, Botrytis, Colletotrichum, Magnaporthe, and many others. Moreover, some strains of Trichoderma are able to effectively suppress the growth of some viral and bacterial plant and soil pathogens, as well as produce some significant nematocidal effects.

In addition to protecting plants from pathogens and pests, root colonization by Trichoderma spp. can enhance root growth and development, crop productivity, resistance to abiotic stresses, and bioavailability of nutrients.

In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquifaciens, B. firmus, B. laterosporus, B. lichenformis, B. megaterium, B. mucilaginosus, B. subtilis), Frateuria (e.g., F. aurantia), Microbacterium (e.g., M. laevaniformans), myxobacteria (e.g., Myxococcus xanthus, Stignalella aurantiaca, Sorangium cellulosum, Minicyslis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), and/or Sphingomonas (e.g., S. paucimobilis).

In one embodiment, the composition comprises B. amyloliquefaciens NRRL B-67928. A culture of this microbe has been deposited with the Agricultural Research Service Northern Regional Research Laboratory (NRRL) Culture Collection, 1815 N. University St., Peoria, IL, USA. The deposit has been assigned accession number NRRL B-67928 by the depository and was deposited on Feb. 26, 2020.

In one embodiment, the composition comprises B. subtilis NRRL B-68031 “B4.” A culture of the B4 microbe has been deposited with the Agricultural Research Service Northern Regional Research Laboratory (NRRL) Culture Collection, 1815 N. University St., Peoria, IL, USA. The deposit has been assigned accession number NRRL B-68031 by the depository and was deposited on May 6, 2021.

In one embodiment, the composition comprises W. anomalus NRRL Y-68030. A culture of this microbe has been deposited with the Agricultural Research Service Northern Regional Research Laboratory (NRRL) Culture Collection, 1815 N. University St., Peoria, IL, USA. The deposit has been assigned accession number NRRL Y-68030 by the depository and was deposited on May 6, 2021.

In one embodiment, the composition comprises Meyerozyma caribbica strain “MEC14XN” NRRL ______. A culture of this microbe has been deposited with the Agricultural Research Service Northern Regional Research Laboratory (NRRL) Culture Collection, 1815 N. University St., Peoria, IL, USA. The deposit has been assigned accession number NRRL ______ by the depository and was deposited on ______.

The subject culture has been deposited under conditions that assure that access to the culture will be available during the pendency of this patent application to one determined by the Commissioner of Patents and Trademarks to be entitled thereto under 37 CFR 1.14 and 35 U.S.C 122. The deposit is available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposit will be stored and made available to the public in accord with the provisions of the Budapest Treaty for the Deposit of Microorganisms, i.e., it will be stored with all the care necessary to keep it viable and uncontaminated for a period of at least five years after the most recent request for the furnishing of a sample of the deposit, and in any case, for a period of at least 30 (thirty) years after the date of deposit or for the enforceable life of any patent which may issue disclosing the culture. The depositor acknowledges the duty to replace the deposit should the depository be unable to furnish a sample when requested, due to the condition of the deposit. All restrictions on the availability to the public of the subject culture deposit will be irrevocably removed upon the granting of a patent disclosing it.

In certain embodiments, the microorganism is one that is capable of fixing and/or solubilizing nitrogen, potassium, phosphorous and/or other micronutrients in soil.

In one exemplary embodiment, the composition further comprises, for example, Myxococcus xanthus, Pseudomonas chlororaphis, Starmerella bombicola, Saccharomyces boulardii, Pichia occidentalis, Pichia kudriavzevii, Wickerhamomyces anomalus (e.g., NRRL Y-68030), mycorrhizal fungi, Meyerozyma guilliermondii and/or Meyerozyma caribbica (e.g., M caribbica “MEC14XN”).

In one embodiment, the microorganism is a nitrogen-fixing microorganism, or a diazotroph, selected from species of, for example, Azospirillum, Azotobacter, Chlorobiaceae, Cyanothece, Frankia, Klebsiella, rhizobia, Trichodesmium, and some Archaea. In a specific embodiment, the nitrogen-fixing microbe is Azotobacter vinelandii, B. amyloliquefaciens NRRL B-67928, Bacillus subtilis NRRL B-68031, Meyerozyma guilliermondii and/or Meyerozyma caribbica (e.g., M. caribbica “MEC14XN”).

In another embodiment, the microorganism is a potassium-mobilizing microorganism, or KMB, selected from, for example, Bacillus mucilaginosus, Frateuria aurantia or Glomus mosseae. In a specific embodiment, the potassium-mobilizing microorganism is Frateuria aurantia.

In yet another embodiment, a phosphorus-mobilizing microorganism can be included, such as, for example, Pichia spp., and Wickerhamomyces anomalus (e.g., NRRL Y-68030).

In one embodiment, the microorganisms in the subject microbe-based composition work synergistically with one another to provide a plethora of benefits to a plant, including improving the plant's immune response.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt, such as sodium bicarbonate or carbonate, sodium sulfate, sodium phosphate, sodium biphosphate, can be included in the formulation.

In one embodiment, additional components can be included to increase the efficacy of the treatment products, such as chelating agents and adherents.

In one embodiment, glucose, glycerol and/or glycerin can be added to the microbe-based product to serve as, for example, an osmoticum during storage and transport. In one embodiment, molasses can be included.

In one embodiment, prebiotics can be added to the microbe-based product to enhance microbial growth. Suitable prebiotics, include, for example, kelp extract, fulvic acid, humate and/or humic acid.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

Advantageously, the compositions can be tailored for use at a specified location. In one embodiment, the microbe growth facility is located on, or near, a site where the microbe-based products will be used (e.g., a citrus grove).

Advantageously, these microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products to improve agricultural production.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### Methods of Improving Plant Immune Responses

In preferred embodiment, methods are provided for improving a plant's immune response, wherein a combination of beneficial microorganisms, and/or their growth by-products, are applied to the plant and/or its surrounding environment. In some embodiments, multiple plants and/or their surrounding environments are treated according to the subject methods.

As used herein, a plant's “surrounding environment” means the soil and/or other medium in which the plant is growing, which can include the rhizosphere. In certain embodiments, the surrounding environment does not extend past, for example, a radius of at least 5 miles, 1 mile, 1,000 feet, 500 feet, 300 feet, 100 feet, 10 feet, 8 feet, or 6 feet from the plant.

In specific embodiments, the methods can comprise applying a microbe-based composition comprising a first microorganism and a second microorganism, and/or a growth by-product of one or both of these microorganisms, to the plant and/or its surrounding environment. Preferably, the first microorganism is a Trichoderma sp. fungus and the second microorganism is a Bacillus sp. bacterium. In specific embodiments, the microbe-based composition is an immune supplement composition according to the subject description.

In one embodiment, additional microorganisms can be applied contemporaneously with the Trichoderma and Bacillus.

In certain embodiments, the microorganisms of the immune supplement composition work synergistically with one another to improve the plant's immune response.

As used herein, “applying” a composition or product to an environment refers to contacting a composition or product with a target or site such that the composition or product can have an effect on that target or site. The effect can be due to, for example, microbial growth and/or interaction with a plant, as well as the action of a metabolite, enzyme, biosurfactant or other microbial growth by-product.

Application can further include contacting the microbe-based product directly with a plant, plant part, and/or the plant's surrounding environment (e.g., the soil or the rhizosphere). The microbe-product can be applied as a seed treatment, or to the soil surface, or to the surface of a plant or plant part (e.g., to the surface of the roots, tubers, stems, flowers, leaves, fruit, or flowers). It can be sprayed, poured, sprinkled, injected or spread as liquid, dry powder, dust, granules, microgranules, pellets, wettable powder, flowable powder, emulsions, microcapsules, oils, gels, pastes or aerosols.

In a specific embodiment, the composition is contacted with one or more roots of the plant. The composition can be applied directly to the roots, e.g., by spraying or dunking the roots, and/or indirectly, e.g., by administering the composition to the soil in which the plant grows (e.g., the rhizosphere). The composition can be applied to the seeds of the plant prior to or at the time of planting, or to any other part of the plant and/or its surrounding environment.

In certain embodiments, the compositions provided herein are applied to the soil surface without mechanical incorporation. The beneficial effect of the soil application can be activated by rainfall, sprinkler, flood, or drip irrigation, and subsequently delivered to, for example, the roots of plants.

Plants and/or their environments can be treated at any point during the process of cultivating the plant. For example, the immune supplement composition can be applied to the soil prior to, concurrently with, or after the time when seeds are planted therein. It can also be applied at any point thereafter during the development and growth of the plant, including when the plant is flowering, fruiting, and during and/or after abscission of leaves.

Furthermore, the composition can be applied prior to infection of a plant by a pest or pathogen, or after infection has occurred.

In one embodiment, the method can be used in a large scale agricultural setting. The method can comprise administering the immune supplement composition into a tank connected to an irrigation system used for supplying water, fertilizers or other liquid compositions to a crop, orchard or field. Thus, the plant and/or soil surrounding the plant can be treated with the immune supplement composition via, for example, soil injection, soil drenching, or using a center pivot irrigation system, or with a spray over the seed furrow, or with sprinklers or drip irrigators. Advantageously, the method is suitable for treating hundreds of acres of crops, orchards or fields at one time.

In one embodiment, the method can be used in a smaller scale setting, such as in a home garden or greenhouse. In such cases, the method can comprise spraying a plant and/or its surrounding environment with the immune supplement composition using a handheld lawn and garden sprayer. The composition can be mixed with water, and optionally, other lawn and garden treatments, such as fertilizers and pesticides. The composition can also be mixed in a standard handheld watering can and poured onto soil.

The methods can comprise adding materials to enhance microbe growth during application (e.g., adding nutrients and/or prebiotics to promote microbial growth). In one embodiment, the nutrient sources can include, for example, sources of nitrogen, potassium, phosphorus, magnesium, proteins, vitamins and/or carbon. In one embodiments, the prebiotics can include, for example, kelp extract, fulvic acid, humate and/or humic acid.

To improve or stabilize the effects of the composition, it can be blended with suitable adjuvants and then used as such or after dilution if necessary. In preferred embodiments, the composition is formulated as a dry powder or as granules, which can be mixed with water and other components to form a liquid product. In one embodiment, the composition can comprise glucose, in addition to an osmoticum substance, to ensure optimum osmotic pressure during storage and transport of the dry product. In one embodiment, the osmoticum substance can be glycerin or glycerol.

Advantageously, the subject invention can be useful for improving the immune response of a plant having compromised health, for example, because the plant is affected by disease and/or disease symptoms. The invention can also be useful for improving the immune response of a plant that is at risk of being affected by a disease.

In certain embodiments, the plants are citrus plants, including, for example, all varieties of orange, lemon, lime, pomelo and grapefruit trees. In certain preferred embodiments, the plants are, or are at risk of being, infected by a Ca. Liberibacter spp. bacterium, such as Candidatus Liberibacter asiaticus, Candidatus Liberibacter africanus and/or Candidatus Liberibacter americanus. In a specific embodiment, the bacterium is Ca. Liberibacter asiaticus (HLB).

In certain embodiments, the plant receiving treatment is healthy, but may be “at risk” of being infected by a pathogen. Plants that are “at risk” of being infected include citrus plants in general; citrus plants growing in a grove where infected trees and/or Ca. Liberibacter vectors, including Asian citrus psyllid and African citrus psyllid, have been detected (including areas wherein citrus quarantines have been issued due to citrus psyllid detection); and citrus plants growing in regions that have experienced loss of citrus trees and/or yields due to HLB infections, including, for example, California, Arizona, Texas, Louisiana, Mississippi, Alabama, Florida, Georgia, South Carolina, Puerto Rico and the U.S. Virgin Islands.

In certain embodiments, the plant may be infected by, or at risk of being infected by, a pathogenic strain of Pseudomonas (e.g., P. savastanoi, P. syringae pathovars); Ralstonia solanacearum; Agrobacterium (e.g., A. tumefaciens); Xanthomonas (e.g., X. oryzae pv. Oryzae, X. campestris pathovars, X. axonopodis pathovars); Erwinia (e.g., E. amylovora); Xylella (e.g., X. fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter asialicus; Pantoea; Burkholderia; Acidovorax; Streptomyces; Spiroplasma; Phytoplasma; citrus canker disease, citrus bacterial spot disease, citrus variegated chlorosis, brown rot, citrus root rot, citrus and/or black spot disease.

In preferred embodiment, the subject methods improve a plant's immune response. As used herein, “improving” in the context of a plant's immune response refers to modulating the plant's immune system to, for example, promote survival in the event of an infection by a pest or pathogen and/or prevent further harm to a plant that is exhibiting symptoms of an infection. “Modulation” means modifying or altering. The modification or alteration can be an enhancement or a reduction.

As used herein, “enhancing” means increasing, boosting, and/or stimulating. For example, enhanced plant health means increasing the plant's ability to thrive, ward off pests and/or diseases, as well as the plant's ability to survive environmental stressors such as droughts and/or overwatering. Enhanced plant growth means increasing the size and/or mass of a plant. Enhanced yields means increasing the market value and quality of the end products produced by the plants in a crop, for example, by increasing the number of fruits per plant, increasing the size of the fruits, and/or increasing the quality of the fruits (e.g., taste, texture).

In one embodiment, the plant's immune response is improved by enhancing the ability of the plant's pattern recognition receptors (PRR) to recognize an invader-associated molecular pattern (IAMP) and/or a pathogenic effector molecule and subsequently react to said recognition by producing and transmitting a signal inside the plant cells, said signal inducing a defense mechanism.

As used herein, a PRR is a modular transmembrane protein anchored to plant cell surfaces containing ligand-binding ectodomains. PRRs include, for example, receptor-like kinases (RLK) and receptor-like proteins (RLP).

According to the subject invention, a PRR can recognize IAMPs, including pathogen, microbe, herbivore, and virus-associated molecular patterns (PAMPs, MAMPs, HAMPs and VAMPs), as well as self-derived compounds (damage-associated molecular patterns, or DAMPs) that are released upon attack by an invader. In preferred embodiments, the invader-associated molecular pattern is a PAMP or a MAMP associated with HLB infection. In a specific embodiment, PAMPs include flagellin peptides (e.g., flg22), peptidoglycan, and/or lipopolysaccharides (LPS).

Modulated plant defense mechanisms according to the subject invention include, but are not limited to, release of an anti-microbial compound in the plant to control pathogenic invaders; production of a reactive oxygen species (ROS); hypersensitive response (HR), or programmed cell death, at the site of infection; alterations in gene expression and/or hormone expression to up- or down-regulate certain defensive and/or protective mechanisms; up-regulation of carbohydrate synthesis; alteration of gene expression encoding proteins involved in cell wall synthesis, assembly and modification, including phloem proteins (e.g., phloem filament protein, PP1, and/or phloem lectin, PP2, which coagulate in the presence of oxygen and are thought to cause sieve tube occlusion); up-regulation of callose deposition in parts of the plant; calcium influx; activation of the mitogen-activated protein kinase (MAPK) cascade; nitric oxide (NO) burst; ethylene production and/or others.

In some embodiments, the plant's immune response is improved via priming, which comprises pre-exposing the plant to an IAMP and/or a pathogenic effector molecule, thus triggering a defense mechanism in the plant prior to the plant being infected by a pathogen and inducing the plant into a state of defense and/or resistance. In certain preferred embodiments, the IAMP and/or effector molecule are associated with a bacterial pathogen.

In some embodiments, the plant's immune response is improved by enhancing the reaction of the plant's PRR upon recognition of an IAMP and/or pathogenic effector molecule. For example, the methods can enhance induction of a defense mechanism in the plant by, for example, increasing the speed at which a signal is produced and/or transmitted by the PRR, and/or increasing the quantity at which a defense mechanism (e.g., a defensive molecule) is produced and/or deployed by the plant.

In certain embodiments, improvement in the plant's immune response comprises reducing a defense mechanism induced by the plant's PRR, wherein the defense mechanism is causing harm to the plant because it is irreversible and/or it is being over-induced in the plant. Such self-harming defense mechanisms can include, for example, hypersensitive response; up-regulation of carbohydrate synthesis; alteration of gene expression encoding proteins involved in cell wall synthesis, assembly and modification, including phloem proteins (e.g., PP1 and/or PP2); up-regulation of callose deposition in parts of the plant.

In one embodiment, the method works by improving the immune health of a plant to enhance the plant's ability to survive and/or fight off infections. In one embodiment, the method controls pathogenic bacteria themselves.

In yet another embodiment, the method controls pests that might act as vectors or carriers for pathogenic bacteria, for example, Asian citrus psyllid. Thus, the subject methods can prevent the spread of plant pathogenic bacteria by controlling these carrier pests.

In certain embodiments, the microbe-based immune supplement composition may also be applied so as to promote colonization of the roots and/or rhizosphere as well as the vascular system of the plant in order to promote plant health and vitality. Thus, nutrient-fixing microbes such as Rhizobium and/or Mycorrhizae can be promoted, as well as other endogenous and exogenous microbes, or their by-products that promote crop growth, health and/or yield.

The present invention can also be used for improving one or more qualities of soil, thereby enhancing the performance of the soils for agricultural, home and gardening purposes. The subject invention can be used to improve any number of qualities in any type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof.

In one embodiment, the method can be used for enhancing penetration of beneficial molecules through the outer layers of root cells.

In one embodiment, the method can be used for improving the drainage and/or dispersal of water in waterlogged soils. In one embodiment, the method can be used for improving water retention in dry soil.

In one embodiment, the method can be used for improving nutrient retention in porous and/or depleted soils.

In certain embodiments, the methods and compositions according to the subject invention reduce damage to a plant caused by pests by about 5%, 10%, 20%, 30%, 40%, 50%, 60% 70%, 80%, or 90% or more, compared to plants growing in an untreated environment.

In certain embodiments, the methods and compositions according to the subject invention lead to an increase in crop yield by about 5%, 10%, 20%, 30%, 40%, 50%, 60% 70%, 80%, or 90% or more, compared to untreated crops.

In one embodiment, the methods of the subject invention lead to a reduction in the number of pests on a plant or in a plant's surrounding environment by about 5%, 10%, 20%, 30%, 40%, 50%, 60% 70%, 80%, or 90% or more, compared to a plant growing in an untreated environment.

In one embodiment, the methods of the subject invention lead to an increase in the mass of a plant by about 5%, 10%, 20%, 30%, 40%, 50%, 60% 70%, 80%, or 90% or more, compared to a plant growing in an untreated environment.

The microbe-based products can be used either alone or in combination with other compounds for efficient improvement of plant immunity, health, growth and/or yields, as well as other compounds for efficient treatment and prevention of plant pathogenic pests. For example, commercial and/or natural fertilizers, antibiotics, pesticides, herbicides and/or soil amendments can be applied contemporaneously with the soil treatment composition.

In certain embodiments, the microbe-based products can be used to enhance the effectiveness of the other compounds, for example, by enhancing the penetration of a drug compound into a plant or pest. The microbe-based products can also be used to supplement other treatments, for example, antibiotic treatments. Advantageously, the subject invention helps reduce the amount of antibiotics that must be administered to a crop or plant in order to be effective at treating and/or preventing bacterial infection.

Advantageously, the present invention can be used without releasing large quantities of inorganic compounds into the environment. Additionally, the compositions and methods utilize components that are biodegradable and toxicologically safe. Thus, the present invention can be used as a “green” soil treatment.

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

As used herein, “crop plants” refer to any species of plant or alga edible by humans or used as a feed for animals or fish or marine animals, or consumed by humans, or used by humans (e.g., textile or cosmetics production), or viewed by humans (e.g., flowers or shrubs in landscaping or gardens) or any plant or alga, or a part thereof, used in industry or commerce or education.

In some embodiments, the crop plant is a plant infected by a pathogenic disease or pest. In specific embodiments, the crop plant is infected with citrus greening disease, and/or a pest that carries such diseases.

In specific preferred embodiments, the crop plant is a citrus plant. Examples of citrus plants according to the subject invention include, but are not limited to, orange trees, lemon trees, lime trees and grapefruit trees. Other examples include Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantiifolia (Key lime), Citrus x aurantium (Bitter orange), Citrus x latifolia (Persian lime), Citrus x limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu.

In some embodiments, the crop plant is a relative of a citrus plant, such as orange jasmine, limeberry, and trifoliate orange (Citrus trifolata).

Other examples of crop plants for which the invention is useful include, but are not limited to, cereals and grasses (e.g., wheat, barley, rye, oats, rice, maize, sorghum, corn, and sod); beets (e.g., sugar and fodder beets); fruit crops (e.g., plants bearing pomaceous fruits, stone fruits, soft fruits, berries, tomatoes, grapes, mango, strawberries, peaches, apples, pears, plums, almonds, bananas, and cherries); leguminous crops (e.g., peanuts, beans, lentils, peas and soya); oil crops (e.g., oilseed, rapeseed, mustard, poppies, olive, soybean, palm, sunflower, coconut, castor, cocoa and ground nuts); cucurbits (e.g., pumpkins, cucumbers, squash and melons); fiber plants (e.g., cotton, flax, hemp and jute); leafy vegetables (e.g., spinach, lettuce, kale and cabbage); root and tuber vegetables (e.g., carrots, parsnips, onions, potatoes, sweet potatoes and yams); Lauraceae (e.g., avocado, Cinnamonium and camphor); and tobacco, nut-bearing plants, herbs, spices, medicinal plants, cacao, cassava, coffee, asparagus, chilies, peppers, eggplants, sugarcane, tea, hops, the plantain family, latex plants, rubber plants, ornamentals, flowers for cutting, and any relatives thereof.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Solid State Fermentation of Bacillus Microbes

For Bacillus spp. spore production, a wheat bran-based media is used. The media is spread onto stainless steel pans in a layer about 1 to 2 inches think and sterilized.

Following sterilization, the pans are inoculated with seed culture. Optionally, added nutrients can be included to enhance microbial growth, including, for example, salts and/or carbon sources such as molasses, starches, glucose and sucrose. To increase the speed of growth and increase the motility and distribution of the bacteria throughout the culture medium, potato extract or banana peel extract can be added to the culture.

Spores of the Bacillus strain of choice are then sprayed or pipetted onto the surface of the substrate and the trays are incubated between 32-40° C. Ambient air is pumped through the oven to stabilize the temperature. Incubation for 48-72 hours can produce 1×10¹⁰ spores/gram or more of the strain.

### Example 2—Solid State Fermentation of Trichoderma

For growing Trichoderma spp., 250 g of nixtamilized corn flour is mixed with deionized water and sterilized in a stainless steel pan, sealed with a lid and pan bands. The corn flour medium is aseptically inoculated with Trichoderma seed culture by spraying or pipetting. The pans are then incubated at 30° C. for 10 days. After 10 days, approximately 10⁹ propagules/gram or more of Trichoderma can be harvested. Trichoderma propagules (conidia and/or hyphae) harvested from one batch can treat, for example, 1,000 to 2,000 acres of land.

### Example 3—Preparation of Microbe-Based Product

The microbes, substrate, and any residual nutrients that result from production using the methods described in Examples 1 and 2 can be blended and/or micronized and dried to form granules or a powder substance. Different strains of microbe are produced separately and then mixed together either before or after drying.

A sealable pouch can be used to store and transport a product containing a mixture of 10⁹ cells/g of T harzianum and 10¹⁰ cells/g of B. amyloliquefaciens. Micronutrients, or other microbes similarly produced, can be added to the product.

To prepare for use, the dry product is dissolved in water. The concentration can reach at least 5×10⁹ to 5×10¹⁰ cells/ml. The product is then diluted with water in a mixing tank to a concentration of 1×10⁶ to 1×10⁷ cells/ml.

One bag can be used to treat approximately 20 acres of crop, or 10 acres of citrus grove.

### Example 4—Starter Materials

Microbial compositions, such as those prepared according to Examples 1-3, can be mixed with and/or applied concurrently with additional “starter” materials to promote initial growth of the microorganisms in the composition. These can include, for example, prebiotics and/or nano-fertilizers (e.g., Aqua-Yield, NanoGro™).

One exemplary formulation of a starter composition comprises:
Soluble potash (K2O) (1.0% to 2.5%, or about 2.0%)
Magnesium (Mg) (0.25% to 0.75%, or about 0.5%)
Sulfur (S) (2.5% to 3.0%, or about 2.7%)
Boron (B) (0.01% to 0.05%, or about 0.02%)
Iron (Fe) (0.25% to 0.75%, or about 0.5%)
Manganese (Mn) (0.25% to 0.75%, or about 0.5%)
Zinc (Zn) (0.25% to 0.75%, or about 0.5%)
Humic acid (8% to 12%, or about 10%)
Kelp extract (5% to 10%, or about 6%)
Water (70% to 85%, or about 77% to 80%).

The microbial inoculant, and/or optional growth-promoting “starter” materials, are mixed with water in an irrigation system tank and applied to soil.

### Example 5—Microbial Strains

The subject invention utilizes beneficial microbial strains. Trichoderma harzianum strains can include, but are not limited to, T-315 (ATCC 20671); T-35 (ATCC 20691); 1295-7 (ATCC 20846); 1295-22 [T-22] (ATCC 20847); 1295-74 (ATCC 20848); 1295-106 (ATCC 20873); T12 (ATCC 56678); WT-6 (ATCC 52443): Rifa T-77 (CMI CC 333646); T-95 (60850); T12m (ATCC 20737); SK-55 (No. 13327; BP 4326 NIBH (Japan)); RR17Bc (ATCC PTA 9708); TSHTH20-1 (ATCC PTA 10317); AB 63-3 (ATCC 18647); OMZ 779 (ATCC 201359); WC 47695 (ATCC 201575); m5 (ATCC 201645); (ATCC 204065); UPM-29 (ATCC 204075); T-39 (EPA 119200); and/or F11Bab (ATCC PTA 9709).

Bacillus amyloliquefaciens strains can include, but are not limited to, NRRL B-67928, FZB24 (EPA 72098-5; BGSC 10A6), TA208, NJN-6, N2-4, N3-8, and those having ATCC accession numbers 23842, 23844, 23843, 23845, 23350 (strain DSM 7), 27505, 31592, 49763, 53495, 700385, BAA-390, PTA-7544, PTA-7545, PTA-7546, PTA-7549, PTA-7791, PTA-5819, PTA-7542, PTA-7790, and/or PTA-7541.

### REFERENCES

Broderson, C., et al. (2014). “Phloem Production in Huanglongbing-affected Citrus Trees.” HortScience 49(1):59-64. (“Broderson et al. 2014”).
Dalio, R. J. D., et al. (2017). “PAMPs, PRRs, effectors and R-genes associated with citrus-pathogen interactions. Annals of Botany 119(5): 749-74. (“Dalio et al. 2017”).
De Graca, J. V., et al. (2016). “Huanglongbing: An overview of a complex pathosystem ravaging the world's citrus.” J. Integrative Plant Biol. 58(4):373-87. (“de Graca et al. 2016”).
Keener, A. B. “Holding Their Ground.” The Scientist Magazine. Feb. 1, 2016. https://www.the-scientist.com/features/holding-their-ground-34128. (“Keener 2016”).
Kehr, J. (2006). “Phloem sap proteins: their identities and potential roles in the interaction between plants and phloem-feeding insects.” J. Exper. Botany 57(4):767-74. (“Kehr 2006”).
Tugizimana, F., et al. (2018). “Metabolomics in Plant Priming Research: The Way Forward?” Int. J. Mol. Sci. 19, 1759, doi:10.3390/ijms19061759. (“Tugizimana et al. 2018”).
Zou, H., et al. (2012). “The Destructive Citrus Pathogen, ‘Candidatus Liberibacter asiaticus’ Encodes a Functional Flagellin Characteristic of a Pathogen-Associated Molecular Pattern.” PLoS ONE 7(9): e46447. (“Zou et al. 2012”).

1-8. (canceled)

9. A method of improving a plant's immune response, the method comprising applying an immune supplement comprising a first microorganism and a second microorganism and/or growth by-products thereof, to a plant and/or its surrounding environment, and, optionally, applying nutrients for enhancing the growth of the first and second microorganisms,
wherein the first microorganism is a spore-forming Trichoderma spp. fungus, and the second microorganism is a spore-forming Bacillus spp. bacterium.

10. The method of claim 9, wherein the Trichoderma fungus is Trichoderma harzianum.

11. The method of claim 9, wherein the Bacillus bacterium is Bacillus amyloliquefaciens.

12. The method of claim 11, wherein the Bacillus bacterium is Bacillus amyloliquefaciens NRRL B-67928.

13. The method of claim 9, wherein applying the immune supplement comprises contacting it directly with the plant's roots or contacting it with soil in which the plant grows.

14-15. (canceled)

16. The method of claim 9, wherein the immune supplement is applied to the plant and/or its surrounding environment using an irrigation system.

17. The method of claim 9, wherein the immune supplement is applied to the plant and/or its surrounding environment contemporaneously with a source of one or more plant nutrients selected from nitrogen, phosphorous and potassium.

18-19. (canceled)

20. The method of claim 9, wherein the plant is infected by a pest or a pathogen.

21. The method of claim 9, wherein improvement in the plant's immune response comprises enhancing the ability of the plant's pattern recognition receptors (PRR) to recognize invader-associated molecular patterns (IAMP) and/or pathogenic effector molecules.

22. The method of claim 21, wherein the IAMP is a pathogen-associated molecular pattern (PAMP).

23-25. (canceled)

26. The method of claim 9, wherein improvement in the plant's immune response comprises priming the plant, or pre-exposing the plant to an IAMP and/or a pathogenic effector molecule, thus triggering a defense mechanism in the plant and inducing the plant into a state of defense and/or resistance prior to infection by a pathogen.

27. The method of claim 9, wherein the improvement in the plant's immune response comprises reducing induction of a defense mechanism by the plant's PRR, wherein the defense mechanism is causing harm to the plant because it is irreversible and/or it is being over-induced.

28. The method of claim 27, wherein the defense mechanism is hypersensitive response.

29. The method of claim 27, wherein the defense mechanism is up-regulation of carbohydrate synthesis.

30. The method of claim 27, wherein the defense mechanism is alteration of gene expression encoding proteins involved in cell wall synthesis, assembly and modification.

31. The method of claim 30, wherein the proteins are phloem proteins (PP).

32. (canceled)

33. The method of claim 27, wherein the defense mechanism is up-regulation of callose deposition in parts of the plant, said parts including midribs of leaves, sieve pores, phloem cell walls, and cambium layers.

34. The method of claim 20, wherein the plant is infected by a Candidatus Liberibacter spp. bacterium.

35. The method of claim 34, wherein the Ca. Liberibacter spp. bacterium is one or more of Ca. Liberibacter asiaticus, Ca. Liberibacter africanus and Ca. Liberibacter americanus.

36. The method of claim 9, wherein the plant is a crop plant.

37. The method of claim 36, wherein the crop plant is a citrus plant selected from Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantiifolia (Key lime), Citrus x aurantium (Bitter orange), Citrus x latifolia (Persian lime), Citrus x limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu.

38. (canceled)
